(19) United States
(12) Patent Application Publication
(10) Pub. No.: US 2025/0202128 A1
(43) Pub. Date: Jun. 19, 2025

(54) Choke Plate Assembly for Isolating Antennas from Electromagnetic Waves

(71) Applicant: The Boeing Company, Arlington, VA (US)

(72) Inventors: Michael Mario LoRé, Mesa, AZ (US); Andrew P. Swart, Gilbert, AZ (US); Michael B. DiVerde, Granite Falls, WA (US); Timothy Allen Caviness, Kent, WA (US); Rolando E. Avila, Mesa, AZ (US); Darin Richard Pankratz, Everett, WA (US); Robert A. DiChiara, JR., Carlsbad, CA (US); Matthew Haviland Brady, Gilbert, AZ (US); Daniel Steven Winkler, Mesa, AZ (US)

(21) Appl. No.: 18/544,614

(22) Filed: Dec. 19, 2023

(51) Int. Cl. H01Q 19/02; H01Q 1/12

(52) U.S. Cl. CPC H01Q 19/021; H01Q 1/12

(57) ABSTRACT

A choke plate assembly comprises a number of electromagnetic resonant structures and a dielectric material. The number of electromagnetic resonant structures suppresses electromagnetic waves travelling through the number of electromagnetic resonant structures. The dielectric material encompasses the number of electromagnetic resonant structures.

### BACKGROUND INFORMATION

### 1. Field

The present disclosure relates generally to antenna systems and, in particular, to isolating antennas and antenna systems using a choke plate assembly.

### 2. Background

Satellite systems are used in aircraft to provide communications. The satellite communications systems used in aircraft operate at different frequencies. For example, a Ku-band satellite system can operate at radio frequencies from 12 GHz to 18 GHZ. A Ka-band satellite system can operate at radio frequencies from 26.5 GHz to 40 GHZ.

The satellite communication systems include satellite antenna systems that can be used for various types of communication for the aircraft. For example, a satellite antenna system for a commercial airplane can be used to provide in-flight connectivity. The satellite antenna system is mounted on top of the commercial airplane. This connectivity can be used for exchanging information used to operate the commercial airplane. Further, this connectivity can also be used for in-flight entertainment, voice calls, internet connections, or data communications for passengers on the commercial airplane. With the use of different frequencies, two or more satellite antennas can be present in the satellite antenna system.

### SUMMARY

An embodiment of the present disclosure provides a choke plate assembly comprising a number of electromagnetic resonant structures and a dielectric material. The number of electromagnetic resonant structures suppresses electromagnetic waves travelling through the number of electromagnetic resonant structures. The dielectric material encompasses the number of electromagnetic resonant structures.

Another embodiment of the present disclosure provides an antenna system comprising a first antenna, a second antenna, and a choke plate assembly. The choke plate assembly has a first end and a second end. The first antenna is adjacent to the first end and the second antenna is adjacent to the second antenna. The choke plate assembly comprises a number of electromagnetic resonant structures and a dielectric material. The number of electromagnetic resonant structures suppresses electromagnetic waves travelling through the number of electromagnetic resonant structures from the first antenna to the second antenna. The dielectric material encompasses the number of electromagnetic resonant structures.

Yet another embodiment of the present disclosure provides a choke plate assembly comprising a number of inductive and capacitive electromagnetic resonant structures and a dielectric material. The number of inductive and capacitive electromagnetic resonant structures suppresses electromagnetic energy travelling along a propagation direction from a first end of the choke plate assembly to a second end of the choke plate assembly, thereby electromagnetically isolating the second end from the first end. The dielectric material encloses the number of inductive and capacitive electromagnetic resonant structures.

Still another embodiment of the present disclosure provides a method for suppressing electromagnetic waves. The electromagnetic waves are received from a first antenna at the first end of a choke plate assembly. The electromagnetic waves that travel through a number of electromagnetic resonant structures in the choke plate assembly towards a second antenna at a second end of the choke plate assembly are suppressed.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of an aircraft in communication with satellites in accordance with an illustrative embodiment;

FIG. 2 is an illustration of a block diagram of a communications environment in accordance with an illustrative embodiment;

FIG. 3 is an illustration of an antenna system in accordance with an illustrative embodiment;

FIG. 4 is an illustration of a cross-sectional view of an antenna system in accordance with an illustrative embodiment;

FIG. 5 is an illustration of electromagnetic resonant structures in a choke plate assembly in accordance with an illustrative embodiment;

FIG. 6 is another illustration of electromagnetic resonant structures in a choke plate assembly in accordance with an illustrative embodiment;

FIG. 7 is yet another illustration of electromagnetic resonant structures in a choke plate assembly in accordance with an illustrative embodiment;

FIG. 8 is still another illustration of electromagnetic resonant structures in a choke plate assembly in accordance with an illustrative embodiment;

FIG. 9 is still another illustration of electromagnetic resonant structures in a choke plate assembly in accordance with an illustrative embodiment;

FIG. 10 is an illustration of a choke plate assembly in accordance with an illustrative embodiment;

FIG. 11 is an illustration of a suppression of electromagnetic waves in accordance with an illustrative embodiment;

FIG. 12 is an illustration of a graph of transmission isolation for a choke plate assembly including a ribbon as an electromagnetic resonant structure in accordance with an illustrative embodiment;

FIG. 13 is another illustration of a graph of transmission isolation for a choke plate assembly including a ribbon as an electromagnetic resonant structure in accordance with an illustrative embodiment;

FIG. 14 is an illustration of a flowchart of a process for suppressing electromagnetic waves in accordance with an illustrative embodiment;

FIG. 15 is an illustration of a block diagram of an aircraft manufacturing and service method in accordance with an illustrative embodiment; and

FIG. 16 is an illustration of a block diagram of an aircraft in which an illustrative embodiment may be implemented.

### DETAILED DESCRIPTION

The illustrative embodiments recognize and take into account one or more different considerations as described herein. For example, a radio frequency (RF) design inadequacy is present in satellite antenna systems with two or more satellite antennas mounted on top of commercial aircraft. These antenna systems have a large footprint on the aircraft.

As a result, the satellite antennas in these systems should be configured such that the satellite antennas use the smallest surface area possible on the commercial aircraft. With this configuration, these satellite antennas are located very close to each other. The physical location of the antennas creates a situation where the satellite antennas can strongly couple to each other. This coupling is an unwanted condition in the operation of the satellite antennas.

When a pair of satellite antennas interact with each other in an unwanted way, the performance of each satellite antenna is degraded. This degradation can occur even if the satellite antennas operate in different bands.

A satellite antenna is able to radiate a radio wave because the satellite antenna is excited by an oscillator that generates the frequencies needed to communicate with the distant satellite it is interacting with to exchange information. No oscillator is perfect in the sense that the oscillator will only broadcast or receive a single frequency when the oscillator is connected to the satellite antenna. During operation, the oscillator generates sidebands. These sidebands can couple to the adjacent satellite antenna.

To mitigate this unwanted interaction between adjacent antennas, a radio frequency (RF) component such as a choke plate assembly can be used. In satellite antenna systems, a choke plate assembly is located between the adjacent antennas.

The choke plate assembly can be a metallic component that comprises structures that have shapes and textures with sizing and spacing relative to each other such that the electromagnetic (EM) energy that would cross from one antenna to the other is choked off. The energy is choked off due to the coupling interaction the choke plate assembly creates when the electromagnetic energy propagates across the choke plate assembly. This electromagnetic energy can be reradiated away from the initial direction some of the electromagnetic energy was traveling, which was toward the adjacent antenna.

Further, it is desirable for the contour or shape of the communication satellite system to be conformal to the outer mold line (OML) of the commercial airplane or other aircraft. This design for the communication satellite system reduces aerodynamic drag. As a result, this type of design can eliminate the need for a radome, an aero shroud, or other structure to cover the satellite antennas. The use of a radome or an aero shroud can cause the satellite communications system to protrude above the outer mold line the commercial airplane by six inches or more.

It is more desirable for the antennas and the choke plate assembly to be conformal to the outer mold line of the fuselage of the commercial airplane. Otherwise, the satellite antennas and choke plate assembly protrude into the airstream in a manner that reduces the aerodynamic performance of the commercial airplane. This reduction in aerodynamic performance can decrease fuel efficiency and increase costs for operating the commercial airplane.

Further, the design of current choke plate assemblies includes structures that extend from the outer mold line over the commercial airplane. As result, the structures can be exposed to the environment as well as reduce aerodynamic performance, which is undesirable.

These current designs for choke plate assemblies can also accumulate contaminants. These contaminants can include water, ice, insects, debris from bird strikes, and other undesired debris. Further, this exposure to contaminants can cause inconsistencies that affect the performance of the choke plate assembly.

Thus, the illustrative embodiments provide a method, apparatus, and system for suppressing electromagnetic waves. The suppression can include at least one of least one of blocking electromagnetic waves, reflecting the electromagnetic waves away from an initial direction of travel for the electromagnetic waves, or dissipating electromagnetic energy in the electromagnetic waves.

The phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In one illustrative example, a choke plate assembly comprises a number of electromagnetic resonant structures and a dielectric material. As used herein, a “number of” when used with reference items means one or more items. For example, a number of electromagnetic resonant structures is one or more electromagnetic resonant structures.

The number of electromagnetic resonant structures suppresses electromagnetic waves travelling through the number of electromagnetic resonant structures. The dielectric material encompasses the number of electromagnetic resonant structures. In the different illustrative examples, the dialect material can reduce the accumulation of contaminants. Further, the use of the dielectric material along with the design of the number of electromagnetic resonant structures can be configured such that the surface of the choke plate assembly is conformal or flush with at least one of the surface of the antennas or the outer mold line of a platform such as an aircraft. In yet another illustrative example, the dielectric material can be selected to be durable such that exposure of the choke plate assembly to the environment does not degrade the choke plate assembly or its performance.

In the illustrative examples, the suppression of electromagnetic waves can also be referred to as choking the electromagnetic waves. This suppression of electromagnetic waves can be for a particular number of frequencies. This number of frequencies can be a single frequency, multiple frequencies that are not contiguous, or a frequency band with continuous frequencies.

In one illustrative example, the portion of the electromagnetic waves that is suppressed or choked is a magnetic field component of the electromagnetic wave. In other words, the suppression in the form of a radio frequency choke bucks the magnetic field. In other words, a pushback occurs on the incident magnetic field of the electromagnetic field that was induced by the electromagnetic field.

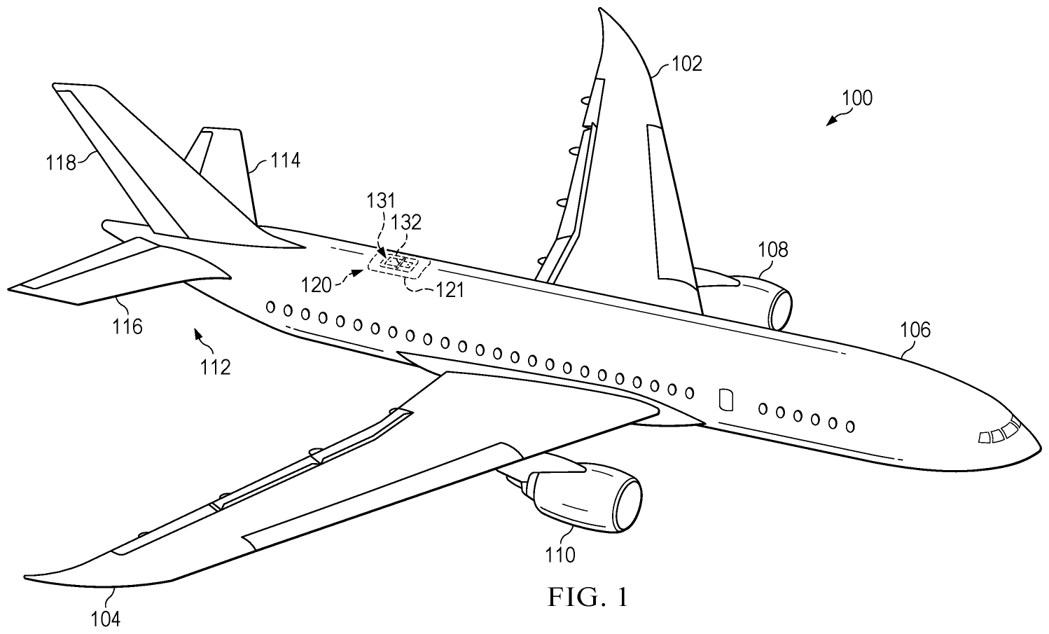

With reference now to the figures and, in particular, with reference to FIG. 1, a pictorial representation of an aircraft in communication with satellites is depicted in accordance with an illustrative embodiment. In this illustrative example, commercial airplane 100 has wing 102 and wing 104 attached to fuselage 106. Commercial airplane 100 includes engine 108 attached to wing 102 and engine 110 attached to wing 104.

Fuselage 106 has tail section 112. Horizontal stabilizer 114, horizontal stabilizer 116, and vertical stabilizer 118 are attached to tail section 112 of fuselage 106.

Commercial airplane 100 is an example of an aircraft in which satellite antenna system 120 can be implemented in accordance with an illustrative embodiment. As depicted, satellite antenna system 120 includes antennas 131 and choke plate assembly 132 on fuselage 106 of commercial airplane 100. Antennas 131 can be two or more antennas. In these examples, antennas 131 and choke plate assembly 132 are held by support structure 121. This support structure can be, for example, an aero shroud, a fairing, a radome, or some other support structure in which these components can be located.

In this illustrative example, choke plate assembly 132 is configured to reduce or prevent electromagnetic waves from traveling from one antenna to another antenna in satellite antenna system 120. Choke plate assembly 132 can suppress electromagnetic waves that travel from one antenna through the choke plate assembly 132 to another antenna. In this manner, the choke plate assembly 132 can reduce interference between antennas in satellite antenna system 120.

Further, in this illustrative example, choke plate assembly 132 is constructed to be durable. In other words, the materials used in choke plate assembly 132 can stand up to the environment in which commercial airplane 100 operates.

Additionally, this choke plate assembly includes a dielectric material that is selected to avoid the collection of undesired materials in choke plate assembly 132. For example, the dielectric material can be selected and formed such that choke plate assembly 132 does not accumulate contaminants such as water, moisture, ice, dust, debris, or other contaminants.

Further, in this example, choke plate assembly 132 is flush to the surface of support structure 121 in which the antennas 131 and choke plate assembly 132 are located. This design can provide increased aerodynamic properties such as aerodynamic airflow.

Thus, choke plate assembly 132 can suppress electromagnetic waves such that interference between antennas 131 does not occur. In other words, choke plate assembly 132 in one example can provide the desired level of isolation in which choke plate assembly 132 is conformal to the outer mold line of fuselage 106 and provides desired isolation of electromagnetic waves to maintain adjacent antenna isolation. Further, choke plate assembly 132 can also provide at least one of durability, reduced accumulation of contaminants, or increased aerodynamic properties. Thus, choke plate assembly 132 can provide optimal antenna functionality and signal fidelity.

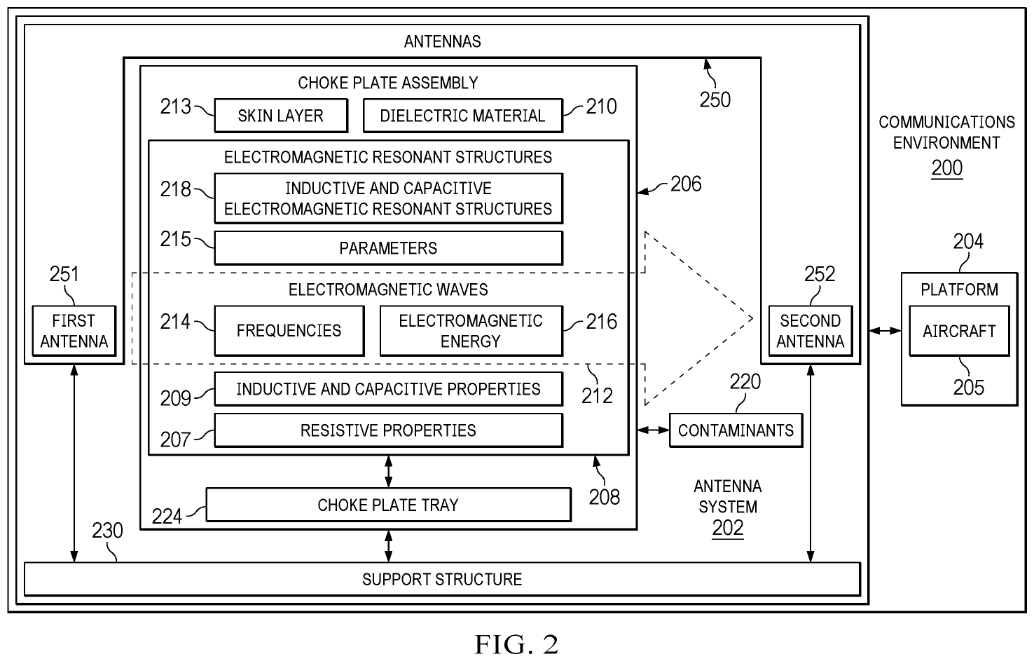

With reference now to FIG. 2, an illustration of a block diagram of a communications environment is depicted in accordance with an illustrative embodiment. In this illustrative example, communications environment 200 includes components that can be implemented in hardware such as the hardware shown for satellite antenna system 120 in FIG. 1.

In this illustrative example, antenna system 202 can be connected to platform 204. When one component is “connected” to another component, the connection is a physical connection. For example, a first component can be considered to be physically connected to a second component by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both. In some examples, the first component can be physically connected to the second component by being located within the second component.

In these examples, antenna system 202 can be a satellite antenna system, a broadcast antenna system, a directional antenna system, and other types of antenna systems. Platform 204 can take number of different forms. For example, platform 204 platform can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle a personal air vehicle, a surface ship, a tank, a personnel carrier, a train, a spacecraft, a space station, a satellite, a submarine, an automobile, a power plant, a bridge, a dam, a house, a manufacturing facility, a building, and other suitable platforms with which antenna system 202 may be used.

In this example, choke plate assembly 206 is located in antenna system 202. Antennas 250 are present in antenna system 202. Antennas 250 can comprise first antenna 251 and second antenna 252.

As depicted, choke plate assembly 206 comprises electromagnetic resonant structures 208 and dielectric material 210. The number of electromagnetic resonant structures 208 suppress electromagnetic waves 212 travelling through the number of electromagnetic resonant structures 208.

In one illustrative example, the number of electromagnetic resonant structures 208 suppresses electromagnetic waves 212 having a number of frequencies 214. In other words, the suppression can be for one or more of frequencies 214 in electromagnetic waves 212. These frequencies can be continuous or noncontiguous.

The suppression of electromagnetic waves 212 can be performed by at least one of blocking electromagnetic waves 212, reflecting electromagnetic waves 212 away from an initial direction of travel for the electromagnetic waves 212, or dissipating electromagnetic energy 216 in electromagnetic waves 212. In this example, the number of electromagnetic resonant structures 208 can have inductive and capacitive properties 209 that reflect electromagnetic waves 212. With these properties, the number of electromagnetic resonant structures 208 can also be referred to as the number of inductive and capacitive electromagnetic resonant structures 218.

Further in this example, the number of electromagnetic resonant structures 208 can also have resistive properties 207. These resistive properties 207 can operate to dissipate electromagnetic energy 216 in electromagnetic waves 212 as these waves travel through the number of electromagnetic resonant structures 208.

The suppression of electromagnetic waves 212 by the number of electromagnetic resonant structures 208 can be based on a number of parameters 215 for electromagnetic resonant structures 208. The number of parameters 215 is selected in this example to suppress electromagnetic waves 212. The number of parameters 215 is selected from at least one of a material, a size, a shape, a pitch, a location, or other parameters for the number of electromagnetic resonant structures 208. The number of electromagnetic resonant structures 208 can be selected from at least one of a post, a wall, a slat, a ring, a conical cylinder, a pyramid, a hole, a slot, a sphere, a ribbon, or some other suitable shape. In one example, the number of electromagnetic resonant structures 208 can be a single structure such as a ribbon.

In these examples, some electromagnetic resonant structures can be comprised of different materials, sizes, shapes, or pitches from other electromagnetic resonant structures. For example, a group of electromagnetic resonant structures 208 may have properties that are different from another group of electromagnetic resonant structures 208. In this example, “a group of” as used herein with items means one or more items. For example, a group of electromagnetic resonant structures is one or more electromagnetic resonant structures.

Dielectric material 210 encompasses (encloses) the number of electromagnetic resonant structures 208. This example, dielectric material 210 can be selected to be a durable material. In other words, the number of dielectric material 210 can be selected to be able to weather environmental conditions encountered by choke plate assembly 206 during use of antenna system 202 with platform 204. In one illustrative example, dielectric material 210 can be selected from at least one of a foam, a solid resin, or some other suitable material.

In selecting the material for dielectric material 210, a permittivity of the material can be considered. The closer the permittivity is to 1.0 is more desirable in these examples. In one illustrative example, the dielectric material has a permittivity that is from about 0.8 to about 1.8. In other examples, other ranges for permittivity can be used depending on the desired properties for dielectric material 210.

Additionally, the material and configuration of dielectric material 210 can be selected to reduce the accumulation of contaminants 220 by choke plate assembly 206. For example, dielectric material 210 encompasses electromagnetic resonant structures 208 in a manner that reduces the accumulation of contaminants 220 by electromagnetic resonant structures 208. These contaminants include at least one of water, ice, insects, debris from bird strikes, or other undesired debris. In other words, the accumulation of water, moisture, debris, ice, or other contaminants may be reduced or prevented. In this manner, the reduction of contaminants 220 avoids a reduction in the performance of choke plate assembly 206. Further, the reduction of contaminants 220 can also be a reduction in contaminants 220 that may impact or otherwise cause inconsistencies in electromagnetic resonant structures 208.

As depicted, choke plate assembly 206 also includes choke plate tray 224. In this example, the number of electromagnetic resonant structures 208 is connected to choke plate tray 224. The number of electromagnetic resonant structures 208 can be connected to choke plate tray 224 in a number of different ways. For example, the number of electromagnetic resonant structures 208 can be formed as part of choke plate tray 224 or bonded or otherwise connected to choke plate tray 224. For example, a workpiece can be machined to form the number of electromagnetic resonant structures 208 and choke plate tray 224 for choke plate assembly 206. In another example, these components can be formed using other techniques such as molding or die casting.

In one illustrative example, the number of electromagnetic resonant structures 208 suppresses electromagnetic waves 212 travelling through the number of electromagnetic resonant structures 208 from first antenna 251 adjacent to a first end of choke plate assembly 206 to second antenna 252 adjacent to a second end of the choke plate assembly 206.

Further, the shape of dielectric material 210 around the number of electromagnetic resonant structures 208 can be made to provide desired aerodynamic properties for antenna system 202. For example, choke plate assembly 206 can be recessed and the top surface of choke plate assembly 206 can be flush with a top surface of support structure 230.

In this example, support structure 230 is a physical structure in antenna system 202 that holds the different components in antenna system 202. As depicted in this example, these components include choke plate assembly 206 and a number of antennas 250.

Support structure 230 can take a number of different forms. For example, support structure 230 can be an aero shroud, radome, a fairing, a blister on a building, or some other suitable type of support structure. In these examples, support structure 230 may not cover the components of antenna system 202. In one illustrative example, support structure 230 can be part of platform 204 rather than a separate structure that is attached to platform 204.

In another example, choke plate assembly 206 can also include skin layer 213. Skin layer 213 covers the number of electromagnetic resonant structures 208 and dielectric material 210. With this example, skin layer 213 covers electromagnetic resonant structures 208 and dielectric material 210 in which choke plate assembly 206 with skin layer 213 is flush with the top surface of platform 204. In this example, platform 204 can be aircraft 205.

Thus, choke plate assembly 206 can reduce interference between antennas 250 in antenna system 202 by suppressing electromagnetic waves 212 to provide a desired level of isolation. Further, choke plate assembly 206 can have a surface that is flush with antennas 250. In some illustrative examples, the entire antenna system is flush with the outer mold line of platform 204 such an aircraft 205. In one illustrative example, skin layer 213 can be located on top of dielectric material 210 to make choke plate assembly 206 flush with other components. Further, dielectric material 210 and, when used, skin layer 213 can provide durability and reduce the collection of contaminants 220 within choke plate assembly 206.

The illustration of communications environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more antennas can be present in antennas 250 in addition to first antenna 251 and second antenna 252. Further, one or more choke plate assemblies can also be present in addition to choke plate assembly 206. These additional choke plate assemblies can be positioned between antennas 250 to suppress electromagnetic waves that may travel through those choke plate assemblies. In yet another illustrative example, antenna system 202 can have a single antenna rather than multiple antennas. With this example, choke plate assembly 206 can be positioned to suppress electromagnetic waves that originate from sources outside of antenna system 202.

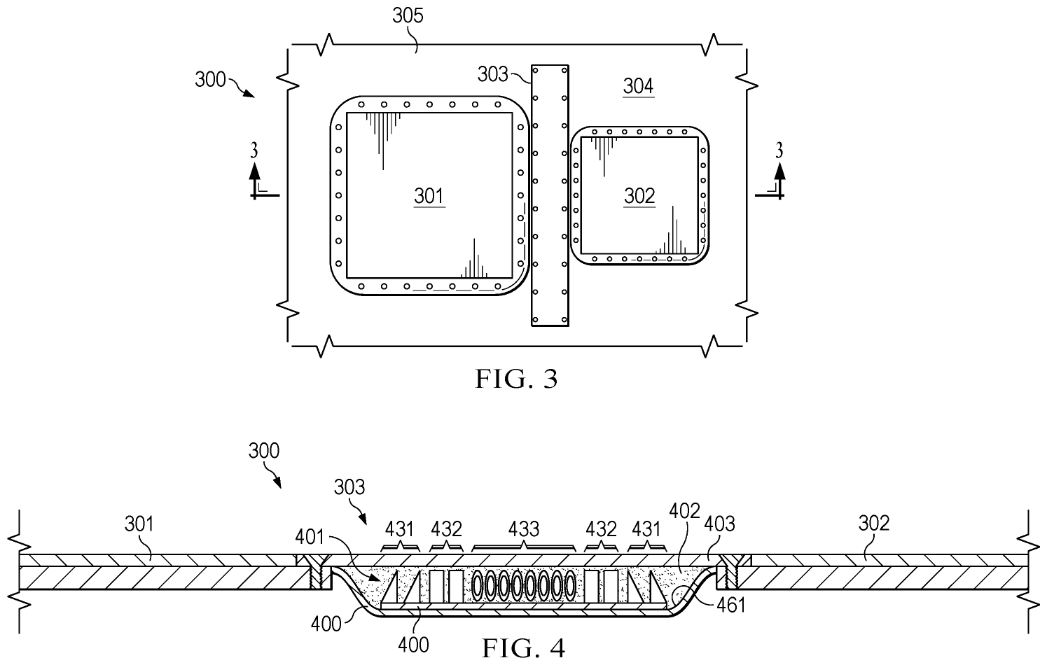

With reference next to FIG. 3, an illustration of an antenna system is depicted in accordance with an illustrative embodiment. In this example, a top view of antenna system 300 is seen on vehicle 305. Antenna system 300 is an example of an implementation for antenna system 202 in FIG. 2. Vehicle 305 is an example of identification for platform 204 in FIG. 2.

As depicted in this view, antenna system 300 includes receiver antenna 301, transmitter antenna 302, and choke plate assembly 303. These components can be seen from top surface 304 of vehicle 305. In this example, choke plate assembly 303 is located between receiver antenna 301 and transmitter antenna 302.

Next in FIG. 4, an illustration of a cross-sectional view of an antenna system is depicted in accordance with an illustrative embodiment. In the illustrative examples, the same reference numeral may be used in more than one figure. This reuse of a reference numeral in different figures represents the same element in the different figures.

In this figure a cross-sectional view of antenna system 300 on vehicle 305 taken along lines 3-3 is shown. Different components in choke plate assembly 303 can be seen in this view. As depicted, choke plate assembly 303 comprises choke plate tray 400, electromagnetic resonant structures 401, dielectric material 402, and skin layer 403.

Choke plate tray 400 is a planar structure on which electromagnetic resonant structures 401 are located. In this example, choke plate tray 400 with electromagnetic resonant structures 401 is located in cavity 461 of choke plate tray 400.

Electromagnetic resonant structures 401 are designed to suppress electromagnetic waves such as radio frequency signals that may travel between receiver antenna 301 and transmitter antenna 302. In this example, multiple types of electromagnetic resonant structures 401 are present. As depicted, type 1 431 are triangular pyramids, type 2 432 are posts, and type 3 433 are rings. In other words, electromagnetic resonant structures 401 do not have to have the same type, sizes, shapes, and pitches.

The dimensions of at least one of choke plate tray 400 or electromagnetic resonant structures 401 can depend on isolation requirements such as the isolation desired between antennas in this example.

In this example, dielectric material 402 encompasses electromagnetic resonant structures 401 and choke plate tray 400 to the extent that these components are not exposed to the environment during operation of antenna system 300. In other words, by encompassing the structures, dielectric material 402 does not have to totally surround these components. Instead encompassing can be such that the components are protected from the environment in which antenna system 300 is used.

When vehicle 305 is an aircraft, dielectric material 402 can be a flight-qualified, low-permittivity dielectric filler. In this example, this means that the material or component will withstand aerodynamic flight or spaceflight. In one example, flight-qualified may mean that the material or component meets at least one of a manufacturing standard or government standard for aerodynamic flight or spaceflight.

In one illustrative example, dielectric material 402 can take the form of a dielectric foam that fills cavity 461. In this example, the location that this dielectric foam fills is cavity 461 for the purpose of keeping out moisture and other contaminants from entering cavity 461.

With the use of a dielectric foam for dielectric material 402, this material can be selected such that it is as close to the permittivity of free space, which is normalized and equal to 1.0. For example, dielectric foams suitable for use can have a relative permittivity of about 1.1 to about 1.8. When used in aircraft, these dielectric foams can be flight-qualified.

Further, the dielectric foam used allows the traveling wave to enter cavity 461 and be strongly coupled to electromagnetic resonant structures 401 in cavity 461 elements. The dielectric foam also plays a role in scaling and tuning the capacitive environment. Since the foam's relative permittivity plays a role in scaling and tuning, the foam selection can be used to tailor the operational bandwidth of choke plate assembly 303. Further, depending on the selection for the dielectric foam, skin layer 403 may not be needed.

In this example, skin layer 403 is a top layer that covers the other components in choke plate assembly 303. In one illustrative example, skin layer 403 can be a composite skin layer that provides protection from the elements and can be conformal to the outer mold line of the fuselage when vehicle 305 is an aircraft. Further, when vehicle 305 is an aircraft, skin layer 403 can be a composite flight-qualified dielectric skin layer.

As depicted, skin layer 403 makes the top surface of choke plate assembly 303 flush with the top surface of receiver antenna 301 and the top surface of transmitter antenna 302. Thus, increased aerodynamic performance can occur with these components having a smooth or flush surface.

Further, skin layer 403 can also be selected to provide radio frequency tuning for choke plate assembly 303. For example, the thickness of skin layer 403 can be varied. In one illustrative example, skin layer 403 can extend into cavity 461 to provide tuning in suppressing electromagnetic waves.

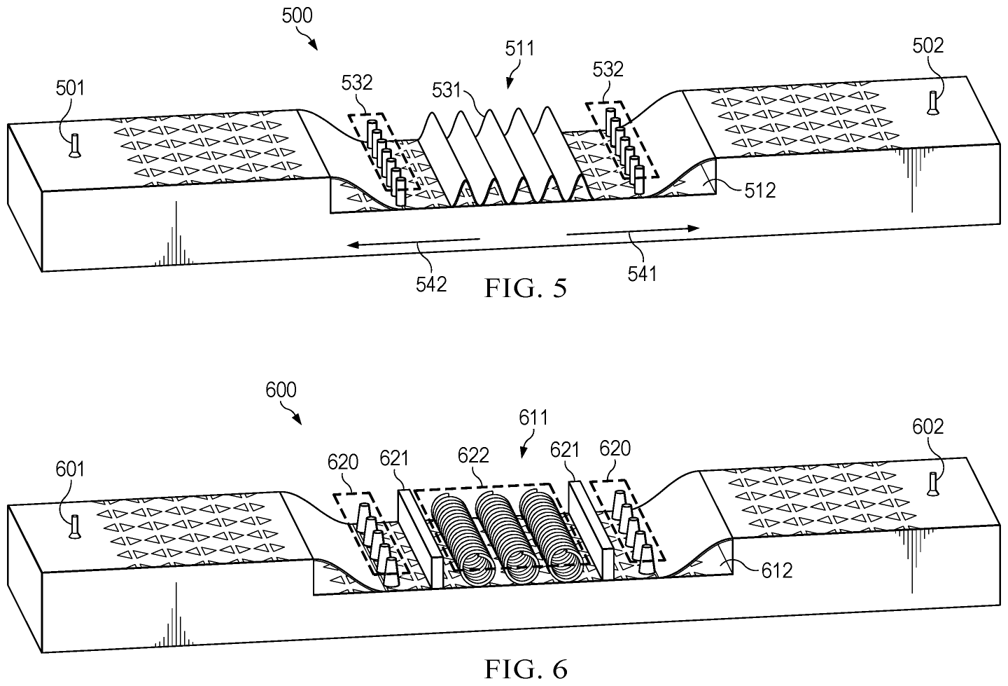

In the illustrative examples, the choke plate tray and the number of electromagnetic resonant structures can be structures. These structures can be formed by at least one of machining, additive manufacturing, or three-dimensional printing. As described above, the number of electromagnetic resonant structures can take different forms depending on the type of isolation desired. In the different illustrative examples, a number of different electromagnetic resonant structures can be used to suppress or choke off the magnetic field component in an electromagnetic wave. Examples of these electromagnetic resonant structures are depicted in FIGS. 5-8 below.

With reference now to FIG. 5, an illustration of electromagnetic resonant structures in a choke plate assembly is depicted in accordance with an illustrative embodiment. In this example, electromagnetic resonant structures 511 for choke plate assembly 500 are located between monopole antenna receiver 501 and monopole antenna transmitter 502. These structures are formed on choke plate tray 512.

In this depicted example, the selection of the different types of electromagnetic resonant structures 511 is made to suppress electromagnetic waves that may travel through choke plate assembly 500. The direction of travel can be the direction of arrow 541 or arrow 542.

As depicted, electromagnetic resonant structures 511 comprise ribbon 531 and posts 532. As depicted, posts 532 are located on either end of ribbon 531. In this example, ribbon 531 and posts 532 have a number of parameters that are selected to suppress electromagnetic waves. These parameters can be selected from at least one of a material, a size, a shape, a pitch (space between the peaks in ribbon 531), or a location of electromagnetic resonant structures 511. These parameters for ribbon 531 and posts 532 all can contribute to the tuned frequency and bandwidth isolation provided by choke plate assembly 500.

Next in FIG. 6, another illustration of electromagnetic resonant structures in a choke plate assembly is depicted in accordance with an illustrative embodiment. In this example, choke plate assembly 600 is located between monopole antenna receiver 601 and monopole antenna transmitter 602.

In this example, electromagnetic resonant structures 611 on choke plate tray 612 for choke plate assembly 600 include posts 620, slats 621, and rings 622. In this example, the different structures in electromagnetic resonant structures 611 are designed to provide isolation between monopole antenna receiver 601 and monopole antenna transmitter 602. In this example, posts 620, slats 621, and rings 622 have parameters that are selected to suppress electromagnetic waves that may travel through electromagnetic resonant structures 611 in choke plate assembly 600.

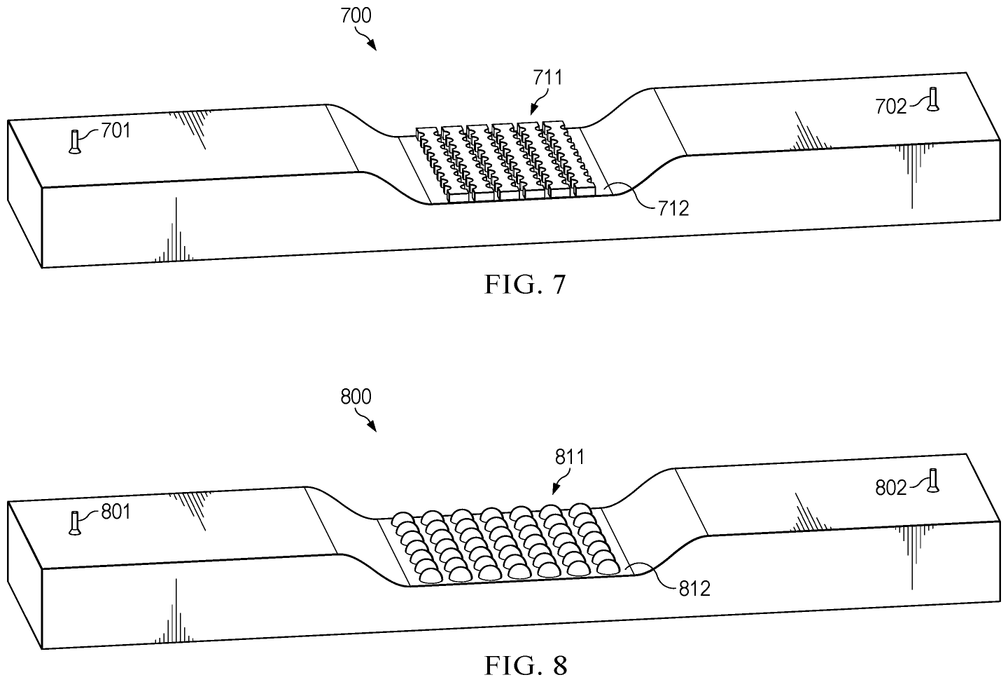

Turning to FIG. 7, yet another illustration of electromagnetic resonant structures in a choke plate assembly sensor is depicted in accordance with an illustrative embodiment. In this example, choke plate assembly 700 is located between monopole antenna receiver 701 and monopole antenna transmitter 702.

In this example, electromagnetic resonant structures 711 on choke plate tray 712 for choke plate assembly 700 comprise holes and slots formed in choke plate tray 712. These holes and slots can be formed by drilling or machining the structures into choke plate tray 712. These holes and slots are designed to provide isolation between monopole antenna receiver 701 and monopole antenna transmitter 702. The holes and slots have a number of parameters that are selected to suppress electromagnetic waves that may travel through electromagnetic resonant structures 711 in choke plate assembly 700.

With reference next to FIG. 8, still another illustration of electromagnetic resonant structures in a choke plate assembly is depicted in accordance with an illustrative embodiment. In this example, choke plate assembly 800 is located between monopole antenna receiver 801 and monopole antenna transmitter 802.

In this example, electromagnetic resonant structures 811 on choke plate tray 812 for choke plate assembly 800 take the form of spheres formed on choke plate tray 812. These spheres are designed to provide isolation between monopole antenna receiver 801 and monopole antenna transmitter 802. A number of parameters for these spheres are selected to suppress electromagnetic waves that may travel through electromagnetic resonant structures 811 in choke plate assembly 800.

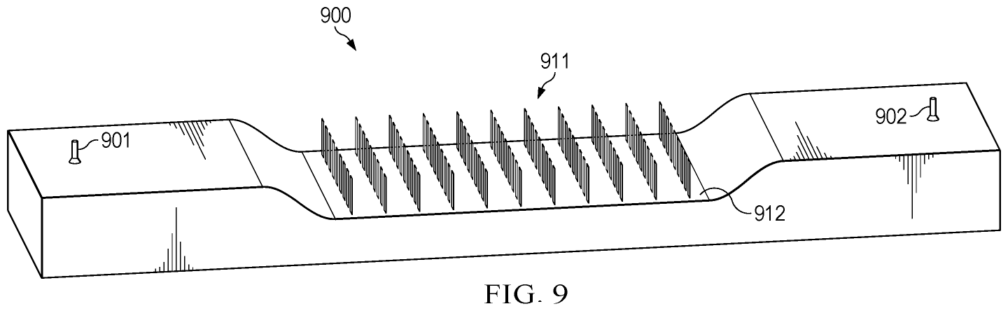

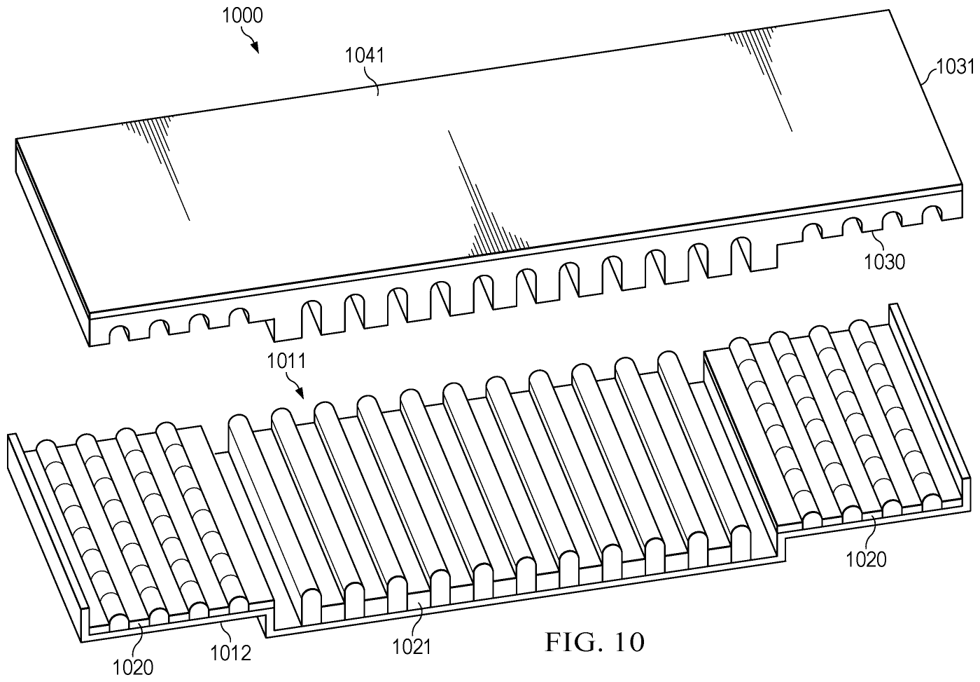

With reference next to FIG. 9, another illustration of electromagnetic resonant structures in a choke plate assembly is depicted in accordance with an illustrative embodiment. In this example, choke plate assembly 900 is located between monopole antenna receiver 901 and monopole antenna transmitter 902.

In this example, electromagnetic resonant structures 911 on choke plate tray 912 for choke plate assembly 900 take the form of posts formed on choke plate tray 912. These posts are designed to provide isolation between monopole antenna receiver 901 and monopole antenna transmitter 902. A number of parameters for these posts are selected to suppress electromagnetic waves that may travel through electromagnetic resonant structures 911 in choke plate assembly 900. For example, these posts can have parameters that cause a resistive load. This resistive load can reduce or dissipate the unity of radio frequency waves.

With reference now to FIG. 10, an illustration of a choke plate assembly is depicted in accordance with an illustrative embodiment. In this example, a semi-exploded view of choke plate assembly 1000 is shown. In this view, electromagnetic resonant structures 1011 on choke plate tray 1012 for choke plate assembly 1000 take the form of slats on choke plate tray 1012. In this example, electromagnetic resonant structures 1011 are capacitive and inductive metal structures that can suppress electromagnetic waves by at least one of blocking the electromagnetic waves or reflecting the electromagnetic waves away from an initial direction of travel for the electromagnetic waves.

Further in this example, lossy magnetic material 1020 and lossy carbon-loaded material 1021 are located on choke plate tray 1012 between electromagnetic resonant structures 1011. These two materials can suppress electromagnetic waves by dissipating the energy in the electromagnetic waves that travel through these materials. The dissipation of the energy can be caused by a resistive load that these materials cause on electromagnetic waves.

Lossy magnetic material 1020 and lossy carbon-loaded material 1021 can be selected materials that can be used for sidelobe suppression. For example, lossy magnetic material 1020 can be a magnetic absorber used for electromagnetic interference (EMI) suppression as gasket components for isolation and radio frequency (RF) attenuation.

In one illustrative example, lossy magnetic material 1020 is comprised of a dielectric binder that incorporates magnetically lossy inclusions. These lossy inclusions can be formed from at least one of an iron powder, an iron alloy powder, or a ferrite powder.

In these examples, this lossy magnetic material can have a thickness from about 0.02 inches to about 0.1 inches. Further, this lossy magnetic material is flexible and soft enough to be cut. Additionally, this lossy magnetic material may also be available in a putty form for casting into specific cavities and forms.

The magnetic inclusions made of iron powders, iron alloy powders, or ferrite powders offer a radio frequency (RF) lossy mechanism to the magnetic field component of the electromagnetic energy impinging on it.

Further in this example, lossy carbon-loaded material 1021 is a volumetric material. This material has a thickness from about 0.25 inches to several inches. Lossy carbon-loaded material 1021 is a volumetric carrier that has a parasitic coating formed from a carbon-inclusion mixture. The volumetric carrier can be a reticulated open cell foam that is mostly air or a material such as anti-static foam that is used to secure electrostatic sensitive electronic components. In these examples, lossy carbon-loaded material 1021 can be soft and porous.

The material can be cut and bonded onto choke plate tray 1012. The carbon in lossy carbon-loaded material 1021 offers a radio frequency (RF) lossy mechanism to the electric field component of the electromagnetic energy impinging on it.

Also, in this semi-exploded view, choke plate assembly 1000 includes dielectric material 1030 and skin layer 1031. Dielectric material 1030 encompasses electromagnetic resonant structures 1011 such that moisture, ice, debris, and other contaminants cannot reach electromagnetic resonant structures 1011. In other words, this material protects the structures from the environment. Further, skin layer 1031 also provides protection from the environment. The use of these two materials can result in top surface 1041 being aligned with and flush to the top of antennas in an antenna assembly. Further, these components can also result in choke plate assembly 1000 being aligned with and flush to the surface of a platform such as the fuselage of an aircraft.

The illustration of the choke plate assemblies in FIGS. 3-10 are examples of choke plate assemblies and these examples are not meant to limit the manner in which other choke plate assemblies can be implemented. For example, in another implementation, the electromagnetic resonant structures can comprise a ribbon. In still other illustrative examples, other types of structures and types of structures can be used for the electrical resonant structures.

Further, although not shown in these examples, a dielectric material encompassing the electromagnetic resonant structures on the choke plate tray is used. Further, a skin layer can also be present that covers the dielectric material and the electromagnetic resonant structures. Thus, choke assemblies can be used and provide versatility in suppressing electromagnetic signals for different types of antennas based on the selection of electromagnetic resonant structures and a number of parameters for the structures.

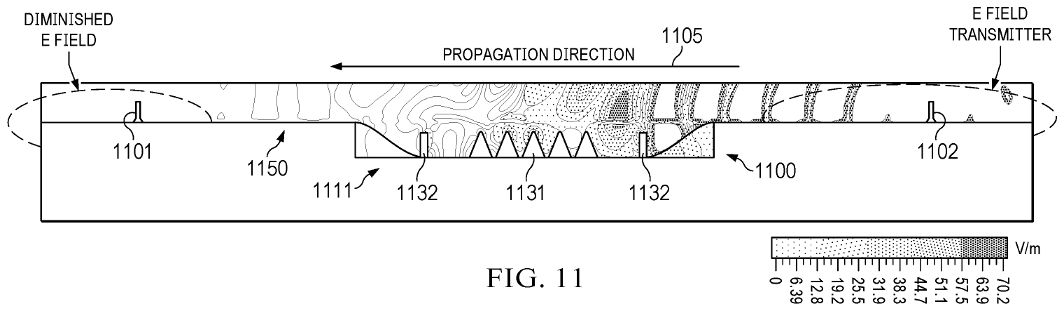

Turning next to FIG. 11, an illustration of a suppression of electromagnetic waves is depicted in accordance with an illustrative embodiment. In this example, an illustration of the coupling of electromagnetic waves under suppression is shown in this figure.

As depicted, choke plate assembly 1100 is located between monopole antenna receiver 1101 and monopole antenna transmitter 1102. As depicted in this example, electromagnetic resonant structures 1111 comprise posts 1132 located on either end of ribbon 1131.

In this illustrative example, monopole antenna transmitter 1102 operates to transmit an electromagnetic wave. Electromagnetic waves travel in propagation direction 1105. As depicted, the strength of the electric field at different locations in propagation direction are depicted by isolines 1150 in which the strength is represented in volts per meter (V/m). In this example, the isolines 1150 represent the electric field lines.

In this example, isolines 1150 provide insight into the role that electromagnetic resonant structures 1111 play in suppressing the electromagnetic field. In this example, the magnetic field, which is in and out of the figure normal to each electric field isoline, is tangent to electromagnetic resonant structures 1111. In this example, the configuration of electromagnetic resonant structures 1111 sets up a strong eddy current response by Lenz's Law. This response is an opposite magnetic field component and bucks the incident magnetic field.

In this example, the parameters for ribbon 1131 include a periodic array selected such that the wavelength period provides the radio frequency tuning needed to achieve the desired isolation. In this example, the electric field lines represented by isolines 1150 depict coupling between electromagnetic resonant structures 1111. The electric field coupling (fringing) is capacitance introduced by the position and shape of ribbon 1131.

The shape of these electromagnetic resonant structures controls the polarizability of the metal elements. This shaping controls the amount of capacitance the fringing fields experience.

Further, the position of these electromagnetic resonant structures 1111 below a composite skin (not shown) is a location parameter that is used in tuning the overall dimensions for electromagnetic resonant structures 1111. The fringing fields are most effective when they do not couple strongly to the composite skin. The structures' inherent inductance and capacitance influence the radio frequency energy. These are the two “circuit components” that define a resonant condition.

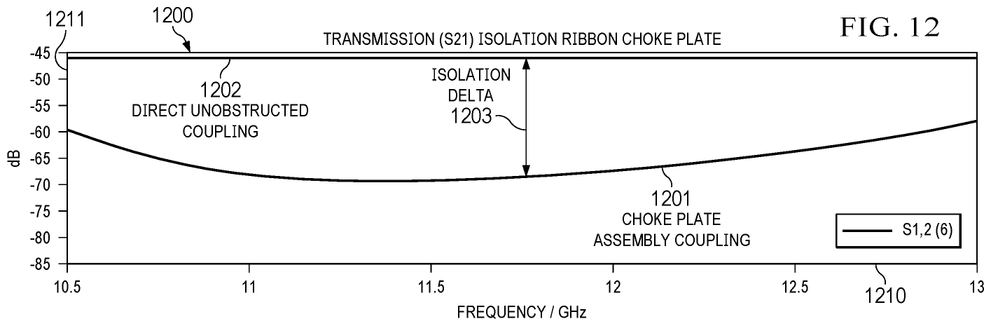

With reference now to FIG. 12, an illustration of a graph of transmission isolation for a choke plate assembly including a ribbon as an electromagnetic resonant structure is depicted in accordance with an illustrative embodiment. In this example, graph 1200 illustrates a reduction in electromagnetic waves for different frequencies. In this example, x axis 1210 represents the frequency in GHz, and y-axis 1211 represents a measure of electromagnetic power in dB. In this example, the transmission can be S21, which represents the ratio of the received power and the emanated power. In this case, this ratio is negative indicating a loss.

In this example, line 1201 in graph 1200 illustrates a level of isolation provided by choke plate assembly 1100 with ribbon 1131 in FIG. 11. Line 1201 represents coupling occurring by choke plate assembly 1100. This isolation in line 1201 can be compared to line 1202 where choke plate assembly 1100 is not present and the two antennas are joined by a smooth metal surface. In this example, line 1201 is at 45 dB. In this example, direct coupling occurs without suppression.

In this example, isolation delta 1203 represents the difference in isolation between the two configurations. This difference represented by isolation delta 1203 varies with frequency. Since the choke plate can be tuned, this is controllable.

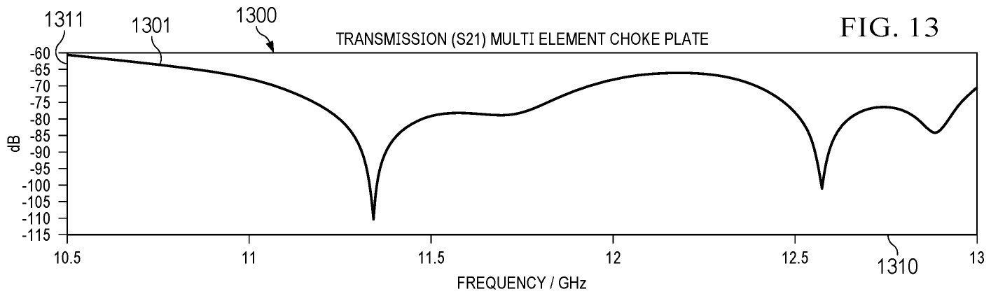

Turning now to FIG. 13, an illustration of a graph of transmission isolation for a choke plate assembly including a ribbon as an electromagnetic resonant structure is depicted in accordance with an illustrative embodiment. In this example, graph 1300 illustrates a reduction in electromagnetic waves for different frequencies. In this example, x axis 1310 represents the frequency in GHz, and y-axis 1311 represents a measurement of electromagnetic waves in dB.

In this graph, line 1301 illustrates the isolation provided by a choke plate assembly using multiple types of electromagnetic resonant structures.

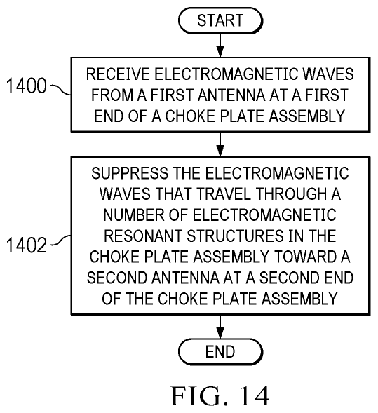

Turning next to FIG. 14, an illustration of a flowchart of a process for suppressing electromagnetic waves is depicted in accordance with an illustrative embodiment. In this example, this process can be implemented in a choke plate assembly such as choke plate assembly 206 shown in block form in FIG. 2. This process can also be implemented using the different choke plate assemblies illustrated in FIGS. 3-10.

The process begins by receiving electromagnetic waves from a first antenna at a first end of a choke plate assembly (operation 1400). The process suppresses the electromagnetic waves that travel through a number of electromagnetic resonant structures in the choke plate assembly toward a second antenna at a second end of the choke plate assembly (operation 1402). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

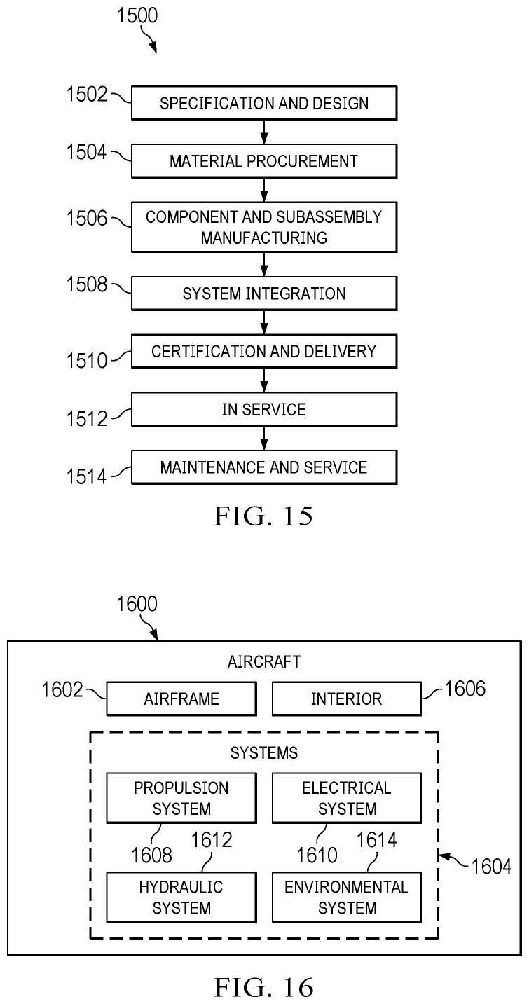

The illustrative embodiments of the disclosure may be described in the context of aircraft manufacturing and service method 1500 as shown in FIG. 15 and aircraft 1600 as shown in FIG. 16. Turning first to FIG. 15, an illustration of a block diagram of an aircraft manufacturing and service method is depicted in accordance with an illustrative embodiment. During pre-production, aircraft manufacturing and service method 1500 may include specification and design 1502 of aircraft 1600 in FIG. 16 and material procurement 1504.

During production, component and subassembly manufacturing 1506 and system integration 1508 of aircraft 1600 in FIG. 16 takes place. Thereafter, aircraft 1600 in FIG. 16 can go through certification and delivery 1510 in order to be placed in service 1512. While in service 1512 by a customer, aircraft 1600 in FIG. 16 is scheduled for routine maintenance and service 1514, which may include modification, reconfiguration, refurbishment, and other maintenance or service.

Each of the processes of aircraft manufacturing and service method 1500 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 16, an illustration of a block diagram of an aircraft is depicted in which an illustrative embodiment may be implemented. In this example, aircraft 1600 is produced by aircraft manufacturing and service method 1500 in FIG. 15 and may include airframe 1602 with plurality of systems 1604 and interior 1606. Examples of systems 1604 include one or more of propulsion system 1608, electrical system 1610, hydraulic system 1612, and environmental system 1614. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1500 in FIG. 15.

In one illustrative example, components or subassemblies produced in component and subassembly manufacturing 1506 in FIG. 15 can be fabricated or manufactured in a manner similar to components or subassemblies produced while aircraft 1600 is in service 1512 in FIG. 15. As yet another example, one or more apparatus embodiments, method embodiments, or a combination thereof can be utilized during production stages, such as component and subassembly manufacturing 1506 and system integration 1508 in FIG. 15. One or more apparatus embodiments, method embodiments, or a combination thereof may be utilized while aircraft 1600 is in service 1512, during maintenance and service 1514 in FIG. 15, or both. The use of a number of the different illustrative embodiments may substantially expedite the assembly of aircraft 1600, reduce the cost of aircraft 1600, or both expedite the assembly of aircraft 1600 and reduce the cost of aircraft 1600.

For example, a choke plate assembly as depicted in the different figures can be manufactured during component and subassembly manufacturing 1506. This choke plate assembly can be used with antennas in antenna system for aircraft 1600 during system integration 1508. Additionally, a choke plate assembly can be implemented into existing antenna systems or with replacement antenna systems during maintenance and service 1514, which can occur during include modification, reconfiguration, refurbishment, and other maintenance or service. In the illustrative examples, a choke plate assembly in the different illustrative examples can operate to isolate antennas to improve the performance of these antennas during operation of aircraft 1600 in in service 1512.

This, illustrative embodiments provide a method, apparatus, and system for suppressing electromagnetic waves. A choke plate assembly comprises a number of electromagnetic resonant structures and a dielectric material. The number of electromagnetic resonant structures suppresses electromagnetic waves travelling through the number of electromagnetic resonant structures. The dielectric material encompasses the number of electromagnetic resonant structures.

This choke plate assembly can reduce interference between antennas in an antenna system by suppressing electromagnetic waves to provide a desired level of isolation. Further, the choke plate assembly can have a surface that is flush with the antennas. In some illustrative examples, the entire antenna system is flush with the outer mold line of a vehicle such as an aircraft. In one illustrative example, a skin layer can be located on top of the dielectric material to make the choke plate assembly flush with other components. Further, the dielectric material and when used the skin layer can provide durability and reduce the collection of contaminants within the choke plate the assembly.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes,” “including,” “has,” “contains,” and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A choke plate assembly comprising:
a number of electromagnetic resonant structures that suppresses electromagnetic waves travelling through the number of electromagnetic resonant structures; and
a dielectric material that encompasses the number of electromagnetic resonant structures.

2. The choke plate assembly of claim 1, further comprising:
a skin layer covering the number of electromagnetic resonant structures and the dielectric material.

3. The choke plate assembly of claim 1, wherein the number of electromagnetic resonant structures is configured to suppress the electromagnetic waves travelling through the number of electromagnetic resonant structures by at least one of blocking electromagnetic waves, reflecting the electromagnetic waves away from an initial direction of travel for the electromagnetic waves, or dissipating electromagnetic energy in the electromagnetic waves.

4. The choke plate assembly of claim 1, further comprising:
a choke plate tray, wherein the number of electromagnetic resonant structures is connected to the choke plate tray.

5. The choke plate assembly of claim 1, wherein the number of electromagnetic resonant structures is configured to suppress the electromagnetic waves travelling through the number of electromagnetic resonant structures from a first antenna adjacent to a first end of the choke plate assembly to a second antenna adjacent to a second end of the choke plate assembly.

6. The choke plate assembly of claim 1, wherein the number of electromagnetic resonant structures is selected from at least one of a post, a wall, a slat, a ring, a conical cylinder, a pyramid, a hole, a slot, a sphere, or a ribbon.

7. The choke plate assembly of claim 1, wherein the dielectric material is selected from at least one of a foam or a solid resin.

8. The choke plate assembly of claim 1, wherein the dielectric material has a permittivity that is from about 0.8 to about 1.8.

9. The choke plate assembly of claim 1, wherein the number of electromagnetic resonant structures is configured to suppress the electromagnetic waves having a number of frequencies.

10. The choke plate assembly of claim 1, wherein the number of electromagnetic resonant structures are a number of inductive and capacitive electromagnetic resonant structures.

11. The choke plate assembly of claim 1, wherein the number of electromagnetic resonant structures has a number of parameters selected to suppress the electromagnetic waves, and wherein the number of parameters is selected from at least one of a material, a size, a shape, a pitch, or a location of the number of electromagnetic resonant structures.

12. The choke plate assembly of claim 1, wherein the number of electromagnetic resonant structures and the dielectric material are located in a platform and the platform is selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle a personal air vehicle, a surface ship, a tank, a personnel carrier, a train, a spacecraft, a space station, a satellite, a submarine, an automobile, a power plant, a bridge, a dam, a house, a manufacturing facility, or a building.

13. An antenna system comprising:
a first antenna;
a second antenna;
a choke plate assembly having a first end and a second end, wherein the first antenna is adjacent to the first end and the second antenna is adjacent to the second end, and wherein the choke plate assembly comprises:
a number of electromagnetic resonant structures configured to suppress electromagnetic waves travelling through the number of electromagnetic resonant structures from the first antenna to the second antenna; and
a dielectric material that encompasses the number of electromagnetic resonant structures.

14. The antenna system of claim 13, wherein the choke plate assembly further comprises:
a choke plate tray, wherein the number of electromagnetic resonant structures is connected to the choke plate tray.

15. The antenna system of claim 13, wherein the number of electromagnetic resonant structures is configured to suppress the electromagnetic waves travelling through the number of electromagnetic resonant structures by at least one of blocking electromagnetic waves, reflecting the electromagnetic waves away from an initial direction of travel for the electromagnetic waves, or dissipating electromagnetic energy in the electromagnetic waves.

16. A choke plate assembly, comprising:
a number of inductive and capacitive electromagnetic resonant structures configured to suppress electromagnetic energy travelling along a propagation direction from a first end of the choke plate assembly to a second end of the choke plate assembly, thereby electromagnetically isolating the second end from the first end; and
a dielectric material that encloses the number of inductive and capacitive electromagnetic resonant structures.

17. The choke plate assembly of claim 16, wherein the choke plate assembly is positioned between a first antenna adjacent the first end and a second antenna adjacent the second end.

18. The choke plate assembly of claim 16, wherein the choke plate assembly is recessed and flush with a top surface of a support structure.

19. The choke plate assembly of claim 18, further comprising a skin layer that covers the number of inductive and capacitive electromagnetic resonant structures and the dielectric material in which the skin layer is aligned flush with the top surface of an aircraft.

20. The choke plate assembly of claim 16, wherein the number of inductive and capacitive electromagnetic resonant structures has a number of parameters selected to suppress the electromagnetic waves, and wherein the number of parameters is selected from at least one of a material, a size, a shape, a pitch, or a location of the number of inductive and capacitive electromagnetic resonant structures.

21. A method for suppressing electromagnetic waves, the method comprising:
receiving the electromagnetic waves from a first antenna at the first end of a choke plate assembly; and
suppressing the electromagnetic waves that travel through a number of electromagnetic resonant structures in the choke plate assembly toward a second antenna at a second end of the choke plate assembly.
